(19) United States
(12) Patent Application Publication
(10) Pub. No.: US 2016/0036883 A1
(43) Pub. Date: Feb. 4, 2016

(54) SYSTEMS AND METHODS FOR SELECTIVE TRANSPORT ACCELERATOR OPERATION

(71) Applicant: QUALCOMM Incorporated, San Diego, CA (US)

(72) Inventors: Pavan Kumar Vitthaladevuni, San Diego, CA (US); Yinian Mao, San Diego, CA (US); Punyaslok Purkayastha, San Diego, CA (US); Fatih Ulupinar, San Diego, CA (US)

(21) Appl. No.: 14/446,821

(22) Filed: Jul. 30, 2014

(51) Int. Cl. H04L 29/06; H04L 29/08

(52) U.S. Cl. CPC H04L 65/602; H04L 65/607; H04L 67/1095

(57) ABSTRACT

Systems and methods which are adapted to provide selective transport accelerator operation are disclosed. In operation according to embodiments, one or more functions of transport accelerator operation is selectively bypassed or not based upon particular criteria. Transport accelerator control logic may obtain one or more acceleration selection attributes and, based on the one or more acceleration selection attributes, selectively invoke first functionality of transport accelerator logic of a client device to obtain the content from the content server or bypassing the first functionality of the transport accelerator logic of the client device to obtain the content from the content server. The first functionality may comprise subdividing the user agent's request for content into a plurality of chunk requests for requesting chunks of the content from the content server to provide accelerated delivery of the content to the client device.

### DESCRIPTION OF THE RELATED ART

More and more content is being transferred over available communication networks. Often, this content includes numerous types of data including, for example, audio data, video data, image data, etc. Video content, particularly high resolution video content, often comprises a relatively large data file or other collection of data. Accordingly, a user agent (UA) on an end user device or other client device which is consuming such content often requests and receives a sequence of fragments of content comprising the desired video content. For example, a UA may comprise a client application or process executing on a user device that requests data, often multimedia data, and receives the requested data for further processing and possibly for display on the user device.

Many types of applications today rely on HTTP for the foregoing content delivery. In many such applications the performance of the HTTP transport is critical to the user's experience with the application. For example, live streaming has several constraints that can hinder the performance of a video streaming client. Two constraints stand out particularly. First, media segments become available one after another over time. This constraint prevents the client from continuously downloading a large portion of data, which in turn affects the accuracy of download rate estimate. Since most streaming clients operate on a “request-download-estimate”, loop, it generally does not do well when the download estimate is inaccurate. Second, when viewing a live event streaming, users generally don't want to suffer a long delay from the actual live event timeline. Such a behavior prevents the streaming client from building up a large buffer, which in turn may cause more rebuffering.

If the streaming client operates over Transmission Control Protocol (TCP) (e.g., as do most Dynamic Adaptive Streaming over HTTP (DASH) clients), the foregoing stringent live event timeline contradicts with the typical TCP behavior, which is to slow down when there is a missing or re-ordered packet. The built-in TCP congestion control mechanism aggravates the rebuffering effect during live streaming, while viewers for a live event are more likely willing to skip the rebuffering and jump to the latest event timeline.

The same issues also exists for HTTP-based file download, where there is a deadline for completion of the download, otherwise a penalty is incurred. For example, if a user is trying to access a web page, a picture, or use a web-based application, large download latency can result in the user turning away from the web page or web-based application.

On-demand streaming also suffers from similar constraints. For example, in on-demand streaming the client devices wishes to receive the on-demand stream as fast as possible in the right order to provide playback to the user. The performance of streaming on-demand content is impacted by missing and re-ordered packets, rebuffering, etc.

Various techniques have been developed for providing acceleration with respect to the delivery of content using an implementation of a transport accelerator. Such transport accelerator implementations may, for example, operate to provide caching of data, processing of data requests and/or responses to data requests, etc. in an effort to facilitate expedited delivery of data to a client device. Although providing expedited delivery of data to client devices in some or even many situations, many transport accelerator implementations nevertheless result in undesirable operation in some situations. For example, operation of a transport accelerator can result in increased network congestion, incompatibilities with communication protocols or portions thereof, etc.

### SUMMARY

In one aspect of the disclosure, a method comprises obtaining, by transport accelerator (TA) control logic, one or more acceleration selection attributes, wherein the one or more acceleration selection attributes comprises at least one of an attribute of a user agent's request for content from a content server, or an attribute of the content server. The method of embodiments further comprises selectively invoking first functionality of transport accelerator (TA) logic of a client device to obtain the content from the content server or bypassing the first functionality of the TA logic of the client device to obtain the content from the content server based on the one or more acceleration selection attributes obtained by the TA control logic of the client device, wherein the first functionality of the TA logic of the client device comprises subdividing the user agent's request for content into a plurality of chunk requests for requesting chunks of the content from the content server to provide accelerated delivery of the content to the client device.

In an additional aspect of the disclosure, an apparatus comprises means for transport accelerator (TA) control logic obtaining one or more acceleration selection attributes, wherein the one or more acceleration selection attributes comprises at least one of an attribute of a user agent's request for content from a content server, or an attribute of the content server. The apparatus of embodiments further comprises means for selectively invoking first functionality of transport accelerator (TA) logic of a client device to obtain the content from the content server or bypassing the first functionality of the TA logic of the client device to obtain the content from the content server based on the one or more acceleration selection attributes obtained by the TA control logic of the client device, wherein the first functionality of the TA logic of the client device comprises subdividing the user agent's request for content into a plurality of chunk requests for requesting chunks of the content from the content server to provide accelerated delivery of the content to the client device.

In an additional aspect of the disclosure, a computer program product has a computer-readable medium having program code recorded thereon. This program code includes program code to obtain, by transport accelerator (TA) control logic, one or more acceleration selection attributes, wherein the one or more acceleration selection attributes comprise at least one of an attribute of a user agent's request for content from a content server, or an attribute of the content server. The program code of embodiments further includes program code to selectively invoke first functionality of transport accelerator (TA) logic of a client device to obtain the content from the content server or bypassing the first functionality of the TA logic of the client device to obtain the content from the content server based on the one or more acceleration selection attributes obtained by the TA control logic of the client device, wherein the first functionality of the TA logic of the client device comprises subdividing the user agent's request for content into a plurality of chunk requests for requesting chunks of the content from the content server to provide accelerated delivery of the content to the client device.

In an additional aspect of the disclosure, an apparatus includes at least one processor and a memory coupled to the processor. The processor is configured to obtain one or more acceleration selection attributes by transport accelerator (TA) control logic, wherein the one or more acceleration selection attributes comprise at least one of an attribute of a user agent's request for content from a content server, or an attribute of the content server. The processor of embodiments is further configured to selectively invoke first functionality of transport accelerator (TA) logic of a client device to obtain the content from the content server or bypassing the first functionality of the TA logic of the client device to obtain the content from the content server based on the one or more acceleration selection attributes obtained by the TA control logic of the client device, wherein the first functionality of the TA logic of the client device comprises subdividing the user agent's request for content into a plurality of chunk requests for requesting chunks of the content from the content server to provide accelerated delivery of the content to the client device.

### BRIEF DESCRIPTION OF THE DRAWINGS

FIG. 1A shows a system adapted for selective transport accelerator operation according to embodiments of the present disclosure.

FIG. 1B shows a configuration in which a transport accelerator is adapted to provide multiport operation according to embodiments of the present disclosure.

FIG. 2A shows a high level flow chart illustrating operation of transport accelerator control logic to provide selective transport accelerator operation according to embodiments of the present disclosure.

FIG. 2B shows a high level flow chart illustrating operation for selectively invoking functionality of transport accelerator logic according to embodiments of the present disclosure.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the term “content” may include data having video, audio, combinations of video and audio, or other data at one or more quality levels, the quality level determined by bit rate, resolution, or other factors. The content may also include executable content, such as: object code, scripts, byte code, markup language files, and patches. In addition, “content” may also include files that are not executable in nature, such as documents that may need to be opened or other data files that need to be accessed.

As used in this description, the term “fragment” refers to one or more portions of content that may be requested by and/or received at a user device.

As used in this description, the term “streaming content” refers to content that may be sent from a server device and received at a user device according to one or more standards that enable the real-time transfer of content or transfer of content over a period of time. Examples of streaming content standards include those that support de-interleaved (or multiple) channels and those that do not support de-interleaved (or multiple) channels.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

As used herein, the terms “user equipment,” “user device,” and “client device” include devices capable of requesting and receiving content from a web server and transmitting information to a web server. Such devices can be a stationary devices or mobile devices. The terms “user equipment,” “user device,” and “client device” can be used interchangeably.

As used herein, the term “user” refers to an individual receiving content on a user device or on a client device and transmitting information to a website.

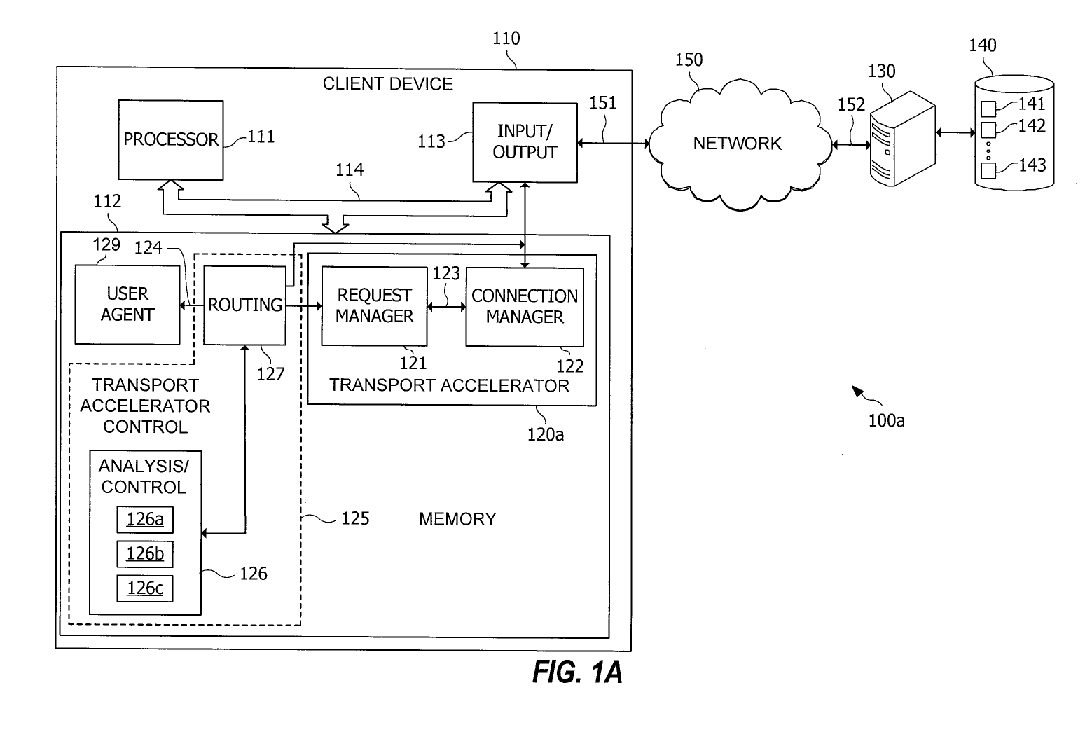

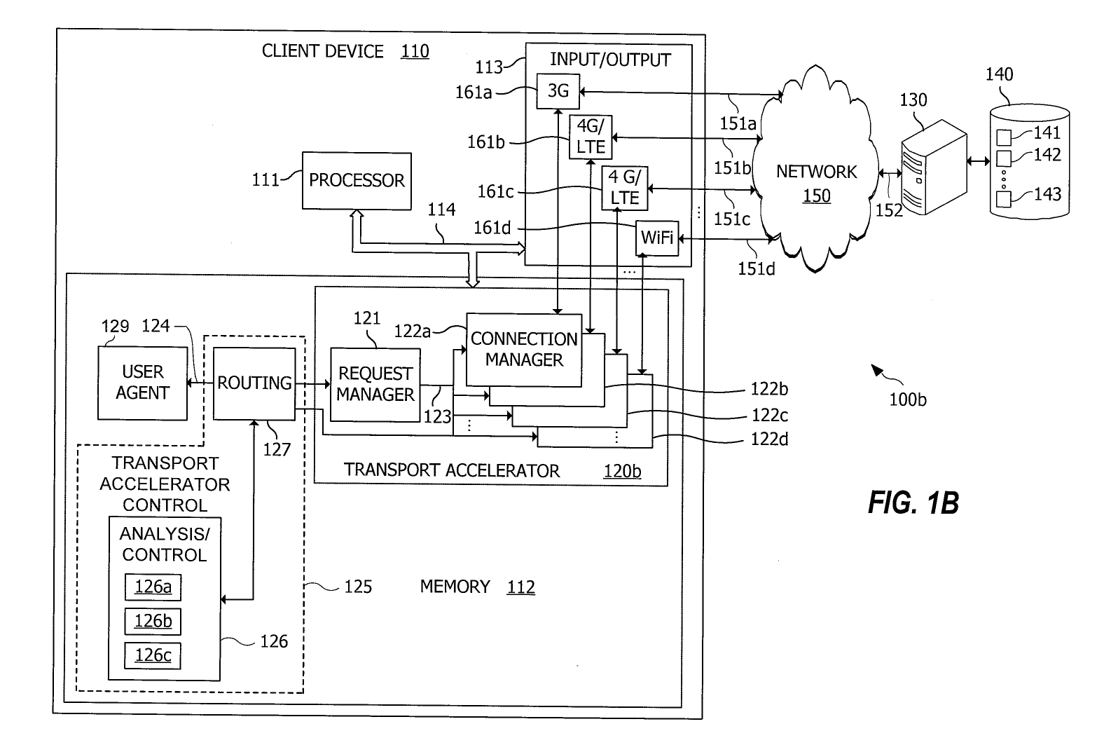

FIGS. 1A and 1B show embodiments of system 100 (the embodiment of FIG. 1A being system 100A and the embodiment of FIG. 1B being 100B) adapted according to the concepts herein to provide transfer of content, such as may comprise audio data, video data, image data, file data, etc., over communication networks. Accordingly, client device 110 is shown in communication with server 130 via network 150, whereby server 130 may transfer various content stored in database 140 to client device 110 in accordance with the concepts of the present disclosure. It should be appreciated that, although only a single client device and a single server and database are represented in FIGS. 1A and 1B, system 100 may comprise a plurality of any or all such devices. For example, server 130 may comprise a server of a server farm, wherein a plurality of servers may be disposed centrally and/or in a distributed configuration, to serve high levels of demand for content transfer. Alternatively, server 130 may be collocated on the same device as transport accelerator 120 (e.g., connected to transport accelerator 120 directly through I/O element 113, instead of through network 150) such as when some or all of the content resides in a database 140 (cache) that is also collocated on the device and provided to transport accelerator 120 through server 130. Likewise, users may possess a plurality of client devices and/or a plurality of users may each possess one or more client devices, any or all of which are adapted for content transfer according to the concepts herein.

Client device 110 may comprise various configurations of devices operable to receive transfer of content via network 150. For example, client device 110 may comprise a wired device, a wireless device, a personal computing device, a tablet or pad computing device, a portable cellular telephone, a WiFi enabled device, a Bluetooth enabled device, a television, a pair of glasses having a display, a pair of augmented reality glasses, or any other communication, computing or interface device connected to network 150 which can communicate with server 130 using any available methodology or infrastructure. Client device 110 is referred to as a “client device” because it can function as, or be connected to, a device that functions as a client of server 130.

Client device 110 of the illustrated embodiment comprises a plurality of functional blocks, shown here as including processor 111, memory 112, and input/output (I/O) element 113. Although not shown in the representation in FIGS. 1A and 1B for simplicity, client device 110 may comprise additional functional blocks, such as a user interface, a radio frequency (RF) module, a camera, a sensor array, a display, a video player, a browser , etc., some or all of which may be utilized by operation in accordance with the concepts herein. The foregoing functional blocks may be operatively connected over one or more buses, such as bus 114. Bus 114 may comprises the logical and physical connections to allow the connected elements, modules, and components to communicate and interoperate.

Memory 112 can be any type of volatile or non-volatile memory, and in an embodiment, can include flash memory. Memory 112 can be permanently installed in client device 110, or can be a removable memory element, such as a removable memory card. Although shown as a single element, memory 112 may comprise multiple discrete memories and/or memory types.

Memory 112 may store or otherwise include various computer readable code segments, such as may form applications, operating systems, files, electronic documents, content, etc. For example, memory 112 of the illustrated embodiments comprises computer readable code segments defining Transport Accelerator (TA) 120, Transport Accelerator (TA) control 125, and UA 129, which when executed by a processor (e.g., processor 111) provide logic circuits operable as described herein. The code segments stored by memory 112 may provide applications in addition to the aforementioned TA 120, TA control 125, and UA 129. For example, memory 112 may store applications such as a browser, useful in accessing content from server 130 according to embodiments herein. Such a browser can be a web browser, such as a hypertext transfer protocol (HTTP) web browser for accessing and viewing web content and for communicating via HTTP with server 130 over connections 151 and 152, via network 150, if server 130 is a web server. As an example, an HTTP request can be sent from the browser in client device 110, over connections 151 and 152, via network 150, to server 130. A HTTP response can be sent from server 130, over connections 152 and 151, via network 150, to the browser in client device 110.

UA 129 is operable to request and/or receive content from a server, such as server 130. UA 129 may, for example, comprise a client application or process, such as a browser, a DASH client, a HTTP Live Streaming (HLS) client, etc., that requests data, such as multimedia data, and receives the requested data for further processing and possibly for display on a display of client device 110. For example, client device 110 may execute code comprising UA 129 for playing back media, such as a standalone media playback application or a browser-based media player configured to run in an Internet browser. In operation according to embodiments, UA 129 decides which fragments or sequences of fragments of a content file to request for transfer at various points in time during a streaming content session. For example, a DASH client configuration of UA 129 may operate to decide which fragment to request from which representation of the content (e.g., high resolution representation, medium resolution representation, low resolution representation, etc.) at each point in time, such as based on recent download conditions. Likewise, a web browser configuration of UA 129 may operate to make requests for web pages, or portions thereof, etc. Typically, the UA requests such fragments using HTTP requests.

TA 120 is adapted according to the concepts herein to provide enhanced delivery of fragments or sequences of fragments of desired content (e.g., the aforementioned content fragments as may be used in providing video streaming, file download, web-based applications, general web pages, etc.). For example, TA 120 may operate to subdivide requests for content made by UA 129 into a plurality of chunk requests for controlledly requesting chunks of the content from server 130 in order to provide accelerated delivery of the content to client device 110. TA 120 of embodiments is adapted to allow a generic or legacy UA (i.e., a UA which has not been predesigned to interact with the TA) that only supports a standard interface, such as a HTTP 1.1 interface implementing standardized TCP transmission protocols, for making fragment requests to nevertheless benefit from using the TA executing those requests. Additionally or alternatively, TA 120 of embodiments provides an enhanced interface to facilitate providing further benefits to UAs that are designed to take advantage of the functionality of the enhanced interface. TA 120 of embodiments is adapted to execute fragment requests in accordance with existing content transfer protocols, such as using TCP over a HTTP interface implementing standardized TCP transmission protocols, thereby allowing a generic or legacy content server (i.e., a content server which has not been predesigned to interact with the TA) to serve the requests while providing enhanced delivery of fragments to the UA and client device.

In providing the foregoing enhanced fragment delivery functionality, TA 120 of the embodiments herein comprises architectural components and protocols as described herein. For example, TA 120A of the embodiment illustrated in FIG. 1A comprises Request Manager (RM) 121 and Connection Manager (CM) 122 which cooperate to provide various enhanced fragment delivery functionality. RM 121 may operate to receive and respond to fragment requests from UA 129, to subdivide requested fragments to provide a plurality of corresponding smaller data requests (referred to herein as “chunk requests” wherein the requested data comprises a “chunk”), and to direct chunk requests to CM 122. CM 122 may thus interface with RM 121 to receive chunk requests, send those requests over network 150, receive the responses to their chunk requests, and pass the responses back to RM 121, wherein the fragments requested by UA 129 are resolved from the received chunks by RM 121 and provided to UA 129. Functionality of CM 122 of embodiments operates to decide when to request data of the chunk requests made by RM 121.

In addition to the aforementioned code segments forming applications, operating systems, files, electronic documents, content, etc., memory 112 may include or otherwise provide various registers, buffers, and storage cells used by functional block of client device 110. For example, memory 112 may comprise a play-out buffer, such as may provide a first-in/first-out (FIFO) memory for spooling data of fragments for streaming from server 130 and playback by client device 110.

Processor 111 of embodiments can be any general purpose or special purpose processor capable of executing instructions to control the operation and functionality of client device 110. Although shown as a single element, processor 111 may comprise multiple processors, or a distributed processing architecture.

I/O element 113 can include and/or be coupled to various input/output components. For example, I/O element 113 may include and/or be coupled to a display, a speaker, a microphone, a keypad, a pointing device, a touch-sensitive screen, user interface control elements, and any other devices or systems that allow a user to provide input commands and receive outputs from client device 110. Any or all such components may be utilized to provide a user interface of client device 110. Additionally or alternatively, I/O element 113 may include and/or be coupled to a disk controller, a network interface card (NIC), a radio frequency (RF) transceiver, and any other devices or systems that facilitate input and/or output functionality of client device 110.

In operation to access and play streaming content, client device 110 communicates with server 130 via network 150, using links 151 and 152, to obtain content data (e.g., as the aforementioned fragments) which, when rendered, provide playback of the content. Accordingly, UA 129 may comprise a content player application executed by processor 111 to establish a content playback environment in client device 110. When initiating playback of a particular content file, UA 129 may communicate with a content delivery platform of server 130 to obtain a content identifier (e.g., one or more lists, manifests, configuration files, or other identifiers that identify media segments or fragments, and their timing boundaries, of the desired content). The information regarding the media segments and their timing is used by streaming content logic of UA 129 to control requesting fragments for playback of the content.

FIG. 1B shows an embodiment of client device 110 implementing a multiple interface architecture, such as may be utilized to provide simultaneous multi-port communication support for one or more communication sessions, communication port recovery with respect to communication sessions, etc. Accordingly, TA 120B of client device 110 of the embodiment illustrated in FIG. 1B includes RM 121 and Connection Managers (CMs) 122a-122d which cooperate to provide various enhanced fragment delivery functionality. Correspondingly, I/O element 113 is shown in FIG. 1B as including a plurality of interfaces operable to facilitate data communication, shown as interfaces 161a-161d. RM 121 may likewise be adapted for operation with a plurality of different CM configurations and or to interface concurrently with more than one CM, such as to request data chunks of the same fragment or sequence of fragments from two or more CMs of CMs 122a-122d. Each such CM may, for example, support a different network interface (e.g., a first CM may have a local interface to an on-device cache, a second CM may use HTTP/TCP connections to a 3G network interface, a third CM may use HTTP/TCP connections to a 4G/LTE network interface, a fourth CM may use HTTP/TCP connections to a WiFi network interface, etc.). Correspondingly, the interfaces of I/O element 113 may comprise various configurations operable in accordance with a number of communication protocols. For example, interfaces 161a-161d may provide an interface to a 3G network, 4G/LTE network, a different 4G/LTE network, and WiFi communications, respectively, where TA 120 uses, for example, a transport protocol such as HTTP/TCP, HTTP/xTCP, or a protocol built using User Datagram Protocol (UDP) to transfer data over these interfaces. Each such interface may be operable to provide one or more communication ports for implementing communication sessions, such as via an associated communication link, such as links 151a-151d shown linking the interfaces of I/O element 113 with components of network 150.

It should be appreciated that the number and configuration of interfaces utilized according to embodiments herein are not limited to that shown in FIGS. 1A and 1B. Fewer or more interfaces may be utilized according to embodiments of a transport accelerator, for example. Moreover, one or more such interfaces may provide data communication other than through the network links shown (e.g., links 151a-151d) and/or with devices other than network components (e.g., server 130).

Server 130 comprises one or more systems operable to serve desired content to client devices. For example, server 130 may comprise a standard HTTP web server operable to stream content to various client devices via network 150. Server 130 may include a content delivery platform comprising any system or methodology that can deliver content to user device 110. The content may be stored in one or more databases in communication with server 130, such as database 140 of the illustrated embodiment. Database 140 may be stored on server 130 or may be stored on one or more servers communicatively coupled to server 130. Content of database 140 may comprise various forms of data, such as video, audio, streaming text, and any other content that can be transferred to client device 110 over a period of time by server 130, such as live webcast content and stored media content.

Database 140 may comprise a plurality of different source or content files and/or a plurality of different representations of any particular content (e.g., high resolution representation, medium resolution representation, low resolution representation, etc.). For example, content file 141 may comprise a high resolution representation, and thus high bit rate representation when transferred, of a particular multimedia compilation while content file 142 may comprise a low resolution representation, and thus low bit rate representation when transferred, of that same particular multimedia compilation. Additionally or alternatively, the different representations of any particular content may comprise a Forward Error Correction (FEC) representation (e.g., a representation including redundant encoding of content data), such as may be provided by content file 143. A Uniform Resource Locator (URL), Uniform Resource Identifier (URI), and/or Uniform Resource Name (URN) is associated with all of these content files according to embodiments herein, and thus such URLs, URIs, and/or URNs may be utilized, perhaps with other information such as byte ranges, for identifying and accessing requested data.

Network 150 can be a wireless network, a wired network, a wide area network (WAN), a local area network (LAN), or any other network suitable for the transfer of content as described herein. In an embodiment, network 150 can comprise at least portions of the Internet. Client device 110 can be connected to network 150 over a bi-directional connection, such as is represented by network connection 151. Alternatively, client device 110 can be connected via a uni-directional connection, such as that provided by an Multimedia Broadcast Multimedia System (MBMS) enabled network (e.g., connections 151, 152 and network 150 may comprise a MBMS network, and server 130 may comprise a Broadcast Multicast Service Center (BS-MC) server). The connection can be a wired connection or can be a wireless connection. In an embodiment, connection 151 can be a wireless connection, such as a cellular 4G connection, a wireless fidelity (WiFi) connection, a Bluetooth connection, or another wireless connection. Server 130 can be connected to network 150 over a bi-directional connection, such as represented by network connection 152. Server 130 can be connected to network 150 over a uni-directional connection (e.g., a MBMS network using protocols and services as described in 3GPP TS.26.346 or an ATSC 3.0 network). The connection can be a wired connection or can be a wireless connection.

Client device 110 of the embodiments illustrated in FIGS. 1A and 1B comprises TA 120 operable to provide enhanced delivery of fragments or sequences of fragments of desired content. For example, as discussed above, TA 120 of the illustrated embodiments comprises RM and CM functionality which cooperates to provide various enhanced fragment delivery functionality operable to facilitate expedited delivery of data to client devices in many situations. However, transport acceleration functionality provided by TA 120 may not result in desired operation (e.g., failing to result in expedited delivery of data to the client device or even causing increased network congestion etc.) in all situations. Accordingly, embodiments herein are adapted to provide selective transport accelerator operation, whereby one or more functions of transport accelerator operation is selectively bypassed or not based upon particular criteria.

It should be appreciated that although the illustrations of FIGS. 1A and 1B show a data path bypassing particular transport accelerator functionality, operation in accordance with embodiments may provide implementations in which data is provided to transport acceleration functional blocks, although the transport acceleration functionality is foregone (see, for example, the discussion of the discussion of the “Not-to-Chunk” flag below) and thus “bypassed” according to the concepts herein. However, embodiments in accordance with the concept herein may additionally or alternatively provide implementations in which data is selectively provided to or not provided to such transport acceleration functionality to thus physically bypass the transport acceleration functionality.

In accordance with the foregoing, the embodiments illustrated in FIGS. 1A and 1B include TA control 125 adapted according to the concepts herein to provide selective transport accelerator operation with respect to communication sessions. As described above, TA control 125 may be implemented as computer readable code segments, such as may be stored in memory 112, which when executed by a processor (e.g., processor 111) provide logic circuits operable as described herein. TA control 125 may comprise one or more functional blocks, such as analysis/control logic 126 and routing block 127 of the illustrated embodiment, operable to provide the requisite functionality for operation as described herein. Routing block 127 may comprise physical switching circuitry and/or logical data path redirection circuitry operable under control of analysis/control logic 126 to provide routing of requests as described herein. It should be appreciated that, although shown as disposed within client device 110, embodiments may employ different configurations of TA control functionality. For example, some portion of TA control 125 may be disposed external to client device 110, such as analysis/control logic 126 disposed at server 130 and/or another processor-based system in communication with client device 110, while another portion is disposed at client device 110, such as routing block 127 disposed at client device 110. Likewise, TA control 125, or portions thereof, may be disposed within client device 110 other than as shown in the illustrated embodiment. For example, TA control 125, or some portion thereof (e.g., analysis/control 126 and/or routing block 127), may be disposed within TA 120 of embodiments.

TA control 125 of embodiments operates to distinguish between messages for which transport acceleration is to be provided and messages for which transport acceleration is not to be provided to thereby provide selective transport accelerator operation. For example, as discussed above, TA 120 may operate to subdivide fragment requests into chunk requests (e.g., breaking down HTTP requests into smaller requests to be sent to the server at the opportune times) for facilitating transport acceleration. However, the use of such smaller chunk requests may not provide desired operation in all situations. The operation of breaking the requests into smaller requests and serving those smaller requests has overhead associated therewith. In some cases, such as where the files storing the requested content are themselves small, the increased overhead may result in the transport of the data not having been accelerated. Similarly, where there are particular dependencies between the requests, such as where there are small files that are prerequisites for content expected to be downloaded later, operation to make the subdivided requests can split the requests with respect to this interdependent content such that critical time is lost in the dependency graph and the content is reassembled (e.g., a resultant web page is rendered) more slowly due to the attempted acceleration. As another example, the chunk requests may be made using byte range requests, whereas the server may not support byte range requests (e.g., ignoring the unsupported byte range information in the request and returning a complete file in response to each chunk request). Such situations may result in increased network congestion while failing to provide transport acceleration.

Accordingly, logic of TA control 125 may operate to analyze various attributes indicative of acceleration effectiveness and/or from which acceleration effectiveness may be determined (such attributes being referred to herein as acceleration selection attributes) and, using such acceleration selection attributes, provide selective control of transport acceleration with respect to particular messages. For example, analysis/control logic 126 may obtain one or more acceleration selection attributes and determine if transport acceleration is to be provided by TA 120 with respect to a particular message or communication session. Analysis/control logic 126 may thereafter provide signaling to routing block 127 to cause the requests for that message or communication session to either be provided to TA 120 for transport acceleration operation or bypass TA 120 based upon the foregoing determination.

It should be appreciated that bypassing of transport acceleration operation provided by TA control 125 of embodiments may not fully bypass TA 120, but rather may operate to bypass transport acceleration functionality thereof. For example, embodiments may operate to continue to invoke select functionality of TA 120, such as the multiple interface support of TA 120B shown in FIG. 1B, while bypassing transport acceleration functionality of the transport accelerator. Moreover, bypassing of transport acceleration operation provided by TA control 125 of embodiments may not result in the requests actually bypassing TA 120, but rather result in operation (or particular operation) associated with acceleration not being invoked. For example, requests for which it is determined that transport acceleration is not to be provided may have transport acceleration bypass signaling associated therewith to cause appropriate functionality of TA 120 to forego acceleration operation (e.g., a flag, such as a “Not-to-Chunk” flag, may be set within a header of the request or otherwise provided in association with a request (e.g., as an advisory parameter) to thereby cause RM 121 not to provide chunking of a fragment request), whereby transport acceleration is invoked or not as indicated by the transport acceleration bypass signaling.

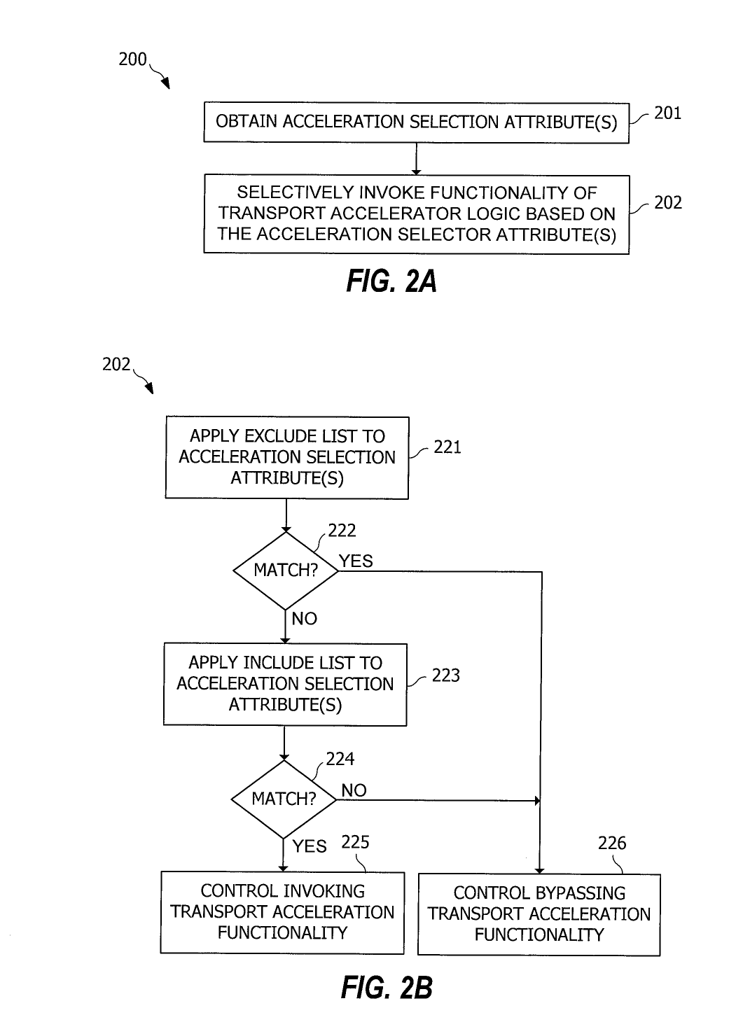

The flow chart of FIG. 2A shows flow 200 illustrating operation of TA control 125 to provide selective transport accelerator operation according to embodiments herein. At block 201 of the illustrated embodiment, one or more acceleration selection attributes are obtained by logic of TA control 125 for use in selective bypassing of one or more functions of TA 120. In operation according to embodiments, logic of TA control 125 may obtain one or more acceleration selection attributes from a request (e.g., fragment and/or chunk request) itself and/or through operation to discover or probe for such acceleration selection attributes. The acceleration selection attributes may comprise an attribute of a user agent's request for content from a content server, an attribute of the content server, etc.

In obtaining one or more acceleration selection attributes from a request, logic of TA control 125 may operate to analyze various aspects of requests, communication protocols utilized with respect to requests, data within requests, etc. to identify information with respect to acceleration selection attributes. For example, TA control logic may operate to analyze such information as the URI, user agent fields, byte range or content length fields, etc. to identify information useful for identifying acceleration selection attributes. In operation according to embodiments, TA control logic may analyze the request to determine the protocol type of the request (e.g., HTTPS, HTTP1.0, HTTP2.0, etc.), properties of the communication session associated with the request (e.g., spdy_enabled, qulc_enabled, upstream_proxy_configured, etc.), the type of request being made (e.g., HTTP GET, PUT, POST, TRACE, OPTIONS, etc.), header information within the request (e.g., byte range header with multiple ranges present, authorization header present, etc.), requested file suffix information (e.g., .mpd, .m3u8, .htm, .html, etc.), user agent information (e.g., user agent known to be compatible with transport acceleration, user agent known not to be compatible with transport acceleration, etc.), URI information (e.g., URI suffix information (such as /videoplayback, .ismv, .isma, /playback/start, /playback/position, .3g2, .3gp, .3gp2, .3gpp, 3gpp2, .m4, .m4e, .m4u, .mp4, .mp4v, .mpeg4, .dash, .ts, .jpg, and .pdf), URI expression information (such as video, audio, .ism, quality levels, fragments, /youku/, and /sohu/), etc.), and/or the like. In operation according to embodiments, a user agent field may be populated with a special value, so as to identify accelerable traffic.

In obtaining one or more acceleration selection attributes through operation to discover or probe for such acceleration selection attributes, logic of TA control 125 may operate to solicit information from which one or more acceleration selection attributes may be determined. For example, where support for transport acceleration operation by a content server is unknown, TA control logic may operate to issue a probing request whereby a response to the probing request may be analyzed to determine one or more acceleration selection attributes (e.g., suitability of the content server for transport acceleration operation). An exemplary implementation of the foregoing may comprise issuing a probing request in the form of a chunk request specifying a byte range of a sub-block of a fragment requested by a user agent. Where the content server does not support byte range requests, the response may include a block of data larger than the requested byte range (e.g., a complete file or fragment). TA control logic may analyze this response in light of the probing request to determine an acceleration selection attribute herein.

Having obtained one or more acceleration selection attributes, operation according to flow 200 of the illustrated embodiment proceeds to block 202 wherein logic of TA control 125 controls selective invocation of functionality of TA 120 (e.g., selectively invoking transport acceleration operation) based on the one or more acceleration selection attributes obtained by the TA control logic. The selective invocation of functionality of TA 120 under control of the TA control logic may operate to cause logic of the transport accelerator to obtain the content from the content server using the aforementioned functionality or cause logic of the transport accelerator to obtain the content from the content server bypassing the aforementioned functionality. For example, TA 120 (particularly RM 121 thereof) may operate to provide subdividing the user agent's request for content into a plurality of chunk requests for requesting chunks of the content from the content server for providing accelerated delivery of the content to the client device. This request “chunking” functionality for transport acceleration may be selectively invoked (e.g., bypassed or not, such as by controlledly bypassing RM 121 and/or other logic of TA 120) under control of TA control logic based upon acceleration selection attributes.

Selective invocation of functionality of TA 120 under control of the TA control logic may, although operating to bypass first functionality of TA 120 (e.g., transport acceleration functionality, such as the aforementioned request chunking operation), may nevertheless operate to utilize other functionality of TA 120. For example, TA 120B illustrated in FIG. 1B provides at least second functionality in the form of multi-port functionality (e.g., provided by operation of CM 122a-122d) which may be utilized irrespective of whether first functionality in the form of transport acceleration functionality (e.g., provided by operation of RM 121) is bypassed or not.

Analysis of the acceleration selection attributes by TA control logic for determining whether functionality of the transport accelerator is to be invoked according to embodiments may employ some general rules and/or assumptions. For example, a rule may be established such that particular protocol types (e.g., HTTPS, HTTP1.0, and HTTP2.0) are not to be accelerated, such as due to their use of tunneling or other features. Similarly, a rule may be established such that only particular types of requests (e.g., HTTP GET requests) are considered for acceleration, while other types of requests (e.g., PUT, POST, TRACE, OPTIONS, etc.) will bypass transport acceleration functionality. As another example, a rule may be established whereby the properties of the network session (e.g., flags “spdy_enabled”, “quic_enabled”, “upstreamproxy_configured”, etc.) with which a request (e.g., GET request) is associated are analyzed to determine if a particular property is present and thus the transport accelerator functionality is to be bypassed or not (e.g., GET requests are to be bypassed if an upstream proxy is configured).

In providing selective invocation of transport accelerator functionality embodiments herein implement a hierarchical rules based analysis through application of both one or more exclude lists and one or more include lists. For example, embodiments of analysis/control 126 comprise exclude list 126a (e.g., identifying GET messages that are bypassed) and include list 126b (e.g., identifying GET messages that get accelerated) utilized in implementing rules based analysis. As will be better understood from the discussion of FIG. 2B below, embodiments operate to first implement an exclude rule set (e.g., apply exclude list 126a to the acceleration selection attributes for a request) and, if no exclude rule is found to apply to the request, then implement an include rule set (e.g., apply include list 126b to the acceleration selection attributes for a request), whereby transport acceleration functionality may be invoked for a request only if the acceleration selection attributes do not meet any exclusion rule and do meet at least one inclusion rule.

Embodiments of analysis/control 126 additionally comprise probing list 126c (e.g., identifying content servers that are not compatible with transport acceleration operation, such as do not support byte range requests) utilized in implementing rules based analysis. The use of such a probing list according to embodiments facilitates dynamically adapting the rules based analysis.

The table below provides an example of an exclude list (e.g., exclude list 126a) as may be utilized according to embodiments herein. This exemplary table identifies particular protocol type of the request, properties of the communication session associated with the request, the type of request being made, header information within the request, and requested file suffix information, which if present in association with a request, the request is to be excluded from transport acceleration operation (e.g., transport acceleration functionality is to be bypassed).

Exclude List

| | | | GET | |
|---|---|---|---|---|
| | | | message | |
| Protocol | | Type of | header | Suffix |
| Type | Session Properties | Message | fields | Matches |
| HTTPS | spdy_enabled | Anything | Byte | .mpd |
| HTTP1.0 | quic_enabled | other than | Range | .m3u8 |
| HTTP2.0 | upstream_proxy_configured | GET | Header | .htm |
| | | | with | .html |
| | | | multiple | |
| | | | ranges | |
| | | | present | |
| | | | Author- | |
| | | | ization | |
| | | | Header | |
| | | | present | |

The following table provides an example of an include list (e.g., include list 126b) as may be utilized according to embodiments herein. This exemplary table identifies particular user agent information, URI information, and URI expression information, which if present in association with a request, the request is to be included in transport acceleration operation (e.g., transport acceleration functionality is not bypassed).

Include List

| | Suffix-Matching | |
|---|---|---|
| | (URI path ends | Reg-Exp Matches (strcmp) on |
| User-Agent Matching | with one of these) | URI path |
| QualcommHTTPClient | /videoplayback | video |
| stagefright/*.* | .ismv | audio |
| | .isma | .ism |
| | /playback/start | QualityLevels |
| | /playback/position | Fragments |
| | .3g2 | /youku/ |
| | .3gp | /sohu/ |
| | .3gp2 | |
| | .3gpp | |
| | .3gpp2 | |
| | .m4 | |
| | .m4e | |
| | .m4u | |
| | .mp4 | |
| | .mp4v | |
| | .mpeg4 | |
| | .dash | |
| | .ts | |
| | .jpg | |
| | .pdf | |

In operation according to embodiments, file extensions are searched in the “path” part of the URI, from right to left (e.g., suffix matching may be used). For example, the file extension in the URI “http://192.168.47.178/content/android/Surf.Video/Surf 4min_{—}10sSeg/qsurf_{—}1538-1.3 gp” is “.3gp”. Such suffix matching may be particularly useful in identifying requests for content having dependencies where there are small files that are prerequisites for content expected to be downloaded later, and thus useful in preventing transport acceleration operation from splitting the requests with respect to this interdependent content.

The particular entries in an exclude list and/or include list may be determined through a number of techniques. For example, entries may be made for certain resources (e.g., content files by suffix, path, or region, user agent by identifying information, content server by identifying information or path, etc.) known a priori to be incompatible or otherwise unsuited for transport acceleration operation. Additionally or alternatively, content transfer may be monitored (e.g., monitoring transport accelerator operation, network congestion, user agent operation, user experience metrics, etc.) to empirically determine compatibility or suitability for transport acceleration operation. Moreover, resources for entry in an exclude list and/or include list may be learned over time, such as based on the responses to requests. For example, learning logic of TA control 125 may operate to populate either or both of the exclude list and/or the include list with information regarding particular content servers and/or other resources, such as based upon support/no support for byte range requests, requests resulting in forbidden or range not-satisfiable responses, etc. Embodiments of the learning logic of TA control 125 may operate to analyze response codes as provided by a content server, perhaps in combination with monitoring operation to serve the requests, to learn which response codes are indicative of the content server compatibility or suitability for transport acceleration operation.

The flow chart of FIG. 2B illustrates operation of TA control 125 according to an embodiment of block 202 to provide selective invocation of functionality of transport accelerator logic based on the acceleration selection attributes using an exclude list and include list. At block 221 of the illustrated embodiment, the exclude list (e.g., exclude list 126a) is applied to one or more of the acceleration selection attributes. In operation according to embodiments, the exclude list (e.g., as may comprise the exclude list table shown above) is applied on a column by column basis (e.g., from left to right) to implement the exclude rules hierarchally. Such a hierarchical application of the exclude rules may be utilized according to embodiments for ease of operation. For example, string searches are generally slower and/or utilize more computing resources than attribute matches, thus attribute searches such as “spdy_enabled” may be performed before any string matching to provide improved performance and/or reduce resource utilization where a match is found early in the application of the exclude rules according to embodiments. At block 222 a determination is made as to whether any of the exclude rules are met (e.g., an acceleration selection attribute matches an entry in the exclude list).

If any one of the exclude conditions is satisfied processing according to the illustrated embodiment proceeds to block 226 wherein transport acceleration functionality is bypassed. For example, logic of TA control 126 may operate to control routing block 127 to cause the request to bypass transport acceleration functionality of TA 120.

If, however, none of the exclude conditions is satisfied processing according to the illustrated embodiment proceeds to block 223. At block 223 of the illustrated embodiment, the include list (e.g., include list 126b) is applied to one or more of the acceleration selection attributes. In operation according to embodiments, the include list (e.g., as may comprise the include list table shown above) is applied on a column by column basis (e.g., from left to right) to implement the include rules hierarchally. As with the application of the aforementioned exclude rules, such a hierarchical application of the include rules may be utilized according to embodiments for ease of operation. At block 222 a determination is made as to whether any of the include rules are met (e.g., an acceleration selection attribute matches an entry in the include list).

If none of the include conditions is satisfied processing according to the illustrated embodiment proceeds to block 226 wherein transport acceleration functionality is bypassed. For example, logic of TA control 126 may operate to control routing block 127 to cause the request to bypass transport acceleration functionality of TA 120.

If, however, any one of the include conditions is satisfied processing according to the illustrated embodiment proceeds to block 225. At block 225 of the illustrated embodiment transport acceleration functionality is implemented with respect to the request. For example, logic of TA control 126 may operate to control routing block 127 to cause the request to be provided to transport acceleration functionality of TA 120.

Operation according to embodiments of the invention may provide selective implementation of transport acceleration functionality in response to determinations in addition to or in the alternative to the aforementioned exclude list and include list analysis. For example, where it is known that a content server does not support transport acceleration operation (e.g., does not support byte ranges where request chunking is utilized for transport acceleration), transport acceleration functionality should be bypassed with respect to requests addressed to that content server according to embodiments. However, the capabilities of the content server are not always known or knowable a priori. Further complicating this issue are the situations wherein content servers support transport acceleration operation (e.g., byte range requests) for certain resources but not others. For example, some conditions indicative of support for transport acceleration may change on a resource-by-resource basis, while others are server properties.

Embodiments may, therefore, implement one or more techniques to determine content server support for transport acceleration operation. Such techniques may, for example, be implemented as part of the aforementioned exclude list analysis (e.g., blocks 221 and 222), part of the aforementioned include list analysis (e.g., blocks 223 and 224), and/or as part of additional or alternative analysis (e.g., a process block provided prior to block 221 where transport acceleration support by the content server is determined, whereby processing proceeds to block 226 if transport acceleration is not supported or processing proceeds to bock 221 if transport acceleration is supported by the content server). Exemplary embodiments will be described herein with reference to content server support for byte range requests to provide a specific example which aids in the understanding of the concepts herein. It should be appreciated, however, that additional or alternative content server operational aspects may be analyzed in determining transport acceleration compatibility. For example, embodiments may analyze responses to one or more requests for particular status codes (e.g., 403 (forbidden) or 416 (range not-satisfiable)) or other parameters indicative of transport acceleration operation with respect to a request not being supported.

Transport acceleration support, such as the aforementioned byte range request support, may not be provided by a particular server for some resources (e.g., .jpg files) while transport acceleration support is supported by that particular server for other resources (e.g., video files). Accordingly, determinations regarding support for transport acceleration operation, such as support for byte range requests, may be made with respect to various resources available through particular servers.

Operation for dealing with a content server which does not support byte ranges may be provided in a number of manners. For example, embodiments may implement a probing list technique for determining where the content server does not to support transport acceleration operation and providing selective implementation of transport acceleration operation herein. Implementation of a probing list technique according to embodiments may utilize a response analysis technique for determining where the content server does not to support transport acceleration operation and providing selective implementation of transport acceleration operation herein.

In implementing a probing list technique according to embodiments, if a request is determined to be in the exclude list (e.g., the server and/or resource associated with the request is included in the exclude list), transport acceleration operation is bypassed. For example, a {server, resource} tuple is first looked up in an exclude list (e.g., exclude list 126a) according to embodiments. If, in this example, the tuple is already in the exclude list, TA control 126 may provide control (e.g., signal routing block 127) to bypass transport acceleration operation with respect to the corresponding requests. However, if the request is determined not to be in the exclude list (e.g., if the tuple is not found on the exclude list), request is looked up in the probing list to determine if the request is already represented in the probing list. The probing list may, for example, contain a list of content servers and/or resources for which it is unknown whether support is provided for transport acceleration (e.g., whether support for byte range requests is provided in the foregoing example).

Assuming the request is not already represented in the probing list, one or more aspects of the request (e.g., the server, resource, etc.) is added to the probing list, and a response analysis technique may thereafter be implemented for determining whether the content server does or does not support transport acceleration operation according to embodiments. For example, a request may be divided into chunks and one or more of the resultant chunk requests sent out to a content server. In operation according to embodiments, a request made to a server on a probing list may be divided into chunks (e.g., by operation of RM 121 under control of TA control 126) and one or more of the resultant chunk requests sent out to a content server under control of TA control 126. The sending of the request may comprise a “probing” request, whereby the content server is being probed to determine support for transport acceleration operation. For example, when it is not known whether a {server, resource/URI} tuple is capable of byte range support, embodiments operate to make 1 sub-request (e.g., a probing request), and then determine subsequent operation based on the response (e.g., using the response headers).

Should the response to the chunk request indicate that the content server does not support byte range requests, and thus does not support the transport acceleration of this example, further chunk requests may be foregone under control of TA control 126 in favor of implementing content requests which bypass the chunking (transport acceleration) operation, possibly discarding the response to the chunk request where it is not useful outside of transport acceleration operation. However, should the response to the chunk request indicate that the content server supports byte range requests, and thus does support the transport acceleration of this example, the transport accelerator functionality may be initiated (or continued) to make further chunk requests in accordance with transport acceleration operation.

In operation according to the foregoing, where the content server does not support byte range requests, the first response may include information regarding conditions indicative of a failure to support transport acceleration. For example, the first response may include particular information indicating byte range requests are not supported, such as a particular status code (e.g., status code 200, not 206), a field with a particular value (e.g., accept ranges field is not set to “bytes”, content range field is present and not the same as the requested byte range, content length field is present and is larger than the byte range requested), etc. Similarly, the first response may not include particular information indicating byte range requests are not supported, such as a particular field (e.g., content range field, the server supports only HTTP1.0 and content length field is not present), etc. Thus, the response to the request may be analyzed by logic of TA control 126 to determine transport acceleration operation support by the content server.

Where it is determined that the content server does not support transport acceleration operation (e.g., when any of the foregoing exemplary conditions have failed), operation according to embodiments operate to dynamically add the content server to an exclude list (e.g., add a {server, resource} tuple, such as the (hostname, file_extension) tuple, to an exclude list), such as exclude list 126a or another exclude list (e.g., as represented by the dynamic exclude list table below) accessible to TA control 126. Thereafter, selective implementation of the transport acceleration functionality may be made with respect to such content servers based upon their inclusion in the exclude list, as described above.

Dynamic Exclude List

| Server | Resource | Timer Value |
|---|---|---|
| Hostname | File_Extension | 1440 min (1 day) |

Because conditions indicative of support for transport acceleration may change on a resource-by-resource basis, embodiments may operate to temporarily include the particular content server determined not to support transport acceleration operation in an exclude list. For example, when dynamically adding the content server to an exclude list in accordance with the above, embodiments may further note a timestamp or timer value for this entry in the exclude list, as shown in the dynamic exclude list table above. In operation according to embodiments, during the time a particular tuple is on the exclude list, requests to that content server will not be accelerated (i.e., transport acceleration functionality will be bypassed). However, once the exclude list timer expires, requests to the content server may be accelerated (e.g., depending upon the transport acceleration control analysis applied with respect thereto).

In implementing the foregoing techniques, embodiments provide an interface between the request dispatcher (e.g., RM 121 and/or CM 122) and the TA control logic (e.g., TA control 126) to communicate information there between, such as the condition that failed the transport acceleration support analysis, advisory parameters, etc. Such an interface may, for example, carry at least the following information from the request dispatcher to the TA control logic: Hostname; Resource (e.g., URI, file_extension); and Condition ID that failed. In the opposite direction (e.g., TA control logic to request dispatcher), the interface may carry one or more advisory parameters, such as the initial number of sub-requests for providing probing requests, transport acceleration bypass control signaling, etc.

For example, where the size of the content requested is initially unknown, RM 121 may not have sufficient information to determine one or more sub-requests (chunk requests) to divide the request into for creating a chunk request (whether for providing transport acceleration operation or probing). Accordingly, an initial number of sub-requests a request is to be subdivided into may be provided by TA control logic 126 to RM 121 as an advisory parameter communicated via the aforementioned interface. Exemplary initial sub-request numbers for particular file types (e.g., as identified by file extension matching) are provided in the advisory parameter table below.

Advisory Parameters

| File extension (through | | Not-to-Chunk |
|---|---|---|
| suffix matching) | Num_sub-requests | flag |
| .jpg | 1 | 1 |
| .pdf | 1 | 0 |
| .3g2 | 4 | 0 |
| .3gp | 4 | 0 |
| .3gp2 | 4 | 0 |
| .3gpp | 4 | 0 |
| .3gpp2 | 4 | 0 |
| .m4 | 4 | 0 |
| .m4e | 4 | 0 |
| .m4u | 4 | 0 |
| .mp4 | 4 | 0 |
| .mp4v | 4 | 0 |
| .mpeg4 | 4 | 0 |
| .dash | 4 | 0 |
| .ts | 4 | 0 |
| .mpd | 1 | 1 |
| .m3u8 | 1 | 1 |
| .htm | 1 | 0 |
| .html | 1 | 0 |
| “*” (wildcard, for all | 1 | 0 |
| others) | | |

Where the request size is known (e.g., the byte range field is populated), the advisory parameter for the initial number of sub-requests may be set to a null value or other inert value (e.g., −1) so as to allow chunking logic (e.g., logic of RM 121) to subdivide the request according to normal protocol. However, if the request size is not known, the advisory parameter may be set in accordance with the advisory parameter table above according to embodiments. For example, if the request is for a *.jpg file that is fetched by GET, the advisory parameter for sub-dividing the request could be 1. If the request is for a *.mp4 file, then the request is for a video file and thus the advisory parameter for sub-dividing the request could be 4.

It should be appreciated that the exemplary advisory parameters of the foregoing table include a “Not-to-Chunk” flag to be sent to the request dispatcher according to embodiments. For example, requests for which it is determined that transport acceleration is not to be provided may have a “Not-to-Chunk” flag set to provide transport acceleration bypass signaling to cause appropriate functionality of TA 120 to forego acceleration operation. Where the “Not-to-Chunk” flag is set as “1”, the associated request is not to be chunked at all, whereby the entire file is requested without chunking according to embodiments. Accordingly, embodiments may utilize a “Not-to-Chunk” flag or similar advisory parameter as an alternative to an exclude list and/or as a means by which to provide control with respect to a transport accelerator so as to bypass transport acceleration functionality, perhaps while providing other functionality by the transport accelerator.

As an example of implementation of the foregoing, when downloading a pdf file whose size is unknown, the “Not-to-Chunk” flag is set to “0”, while the num_sub-requests is set to “1”. Accordingly, logic of TA 120 may be utilized to make an initial request according to transport accelerator normal operation which operates as a probing request. If the size of the requested file is known with the response to the sub-request, the remaining bytes may be calculated by logic of TA 120, and the rest of the requests will be issued over time in accordance with transport acceleration operation. When, however, downloading a jpg/mpd/m3u8 file, the “Not-to-Chunk” flag is set to 1. Accordingly, logic of TA 120 operates to make the GET request for the entire file, without implementing transport acceleration chunking operation. Once the size is known (e.g., as may be determined by information in a response), the total number of chunks may be deduced, and fresh sub-requests may be issued by the logic of TA 120.

The contents of the various tables and lists (e.g., exclude lists, include lists, probing lists, advisory parameters, timer values, etc.) utilized according to embodiments are fully configurable. For example, it may be decided that messages originally to have bypassed the transport acceleration functionality are instead be routed through the transport accelerator framework so as to receive the benefit of other functionality provided thereby (e.g., not invoking first transport accelerator functionality, such as transport acceleration, but invoking second transport accelerator functionality, such as multi-port support or the use of a particular port, etc.). Accordingly, the aforementioned advisory parameters table may be updated to associate a “Not-to-Chunk Flag” set to “1” for the respective tuple providing control to the transport accelerator logic to facilitate selectively not invoking transport acceleration operation while invoking other operation of the transport accelerator (e.g., a Zapped TCP connection that is currently used in the transport accelerator, which provides for port recovery when a connection is not responsive, could be used for non-accelerated requests as well). As another example, exemplary embodiments have been described with reference to looking at GET requests to route them to the transport accelerator or to bypass the transport accelerator, embodiments may operate to parse the responses to GET messages (e.g., the mpd or m3u8 files) to determine information with respect to the stream and use the information for acceleration decisions, such as through corresponding expansion of the exclude lists, include lists, etc.

Consistent with the foregoing, the exclude lists and include lists utilized according to embodiments may be expanded as further information regarding the suitability of particular content servers, resources, etc. for transport acceleration is collected. In operation according to embodiments, transport accelerator control logic (e.g., logic of TA control 126) may access a database (e.g., a centralized server collecting metrics with respect to content server operation), such as from time to time (e.g., every few seconds, every few minutes, daily, upon the occurrence of an event, etc.), to reload or otherwise update an exclude list, include list, proxy list, advisory parameter list, etc.

What is claimed is:

1. A method comprising:
obtaining, by transport accelerator (TA) control logic, one or more acceleration selection attributes comprising at least one of:
an attribute of a user agent's request for content from a content server; or
an attribute of the content server; and
based on the one or more acceleration selection attributes obtained by the TA control logic of the client device, selectively invoking first functionality of transport accelerator (TA) logic of a client device to obtain the content from the content server or bypassing the first functionality of the TA logic of the client device to obtain the content from the content server, the first functionality of the TA logic of the client device comprising subdividing the user agent's request for content into a plurality of chunk requests for requesting chunks of the content from the content server to provide accelerated delivery of the content to the client device.

2. The method of claim 1, wherein the selectively invoking the first functionality of TA logic or bypassing the first functionality of the TA logic comprises bypassing the first functionality of the TA logic; and the method further comprises:
invoking second functionality of the TA logic of the client device when bypassing the first functionality of the TA logic.

3. The method of claim 2, wherein the second functionality of the TA logic provides communication of the content via a plurality of connections established between the client device and the content server.

4. The method of claim 2, wherein the second functionality of the TA logic provides port recovery with respect to communication of the content between the client device and the content server.

5. The method of claim 1, wherein the selectively invoking the first functionality of TA logic or bypassing the first functionality of the TA logic comprises:
routing data to bypass a functional block of the TA logic providing the first functionality of the TA logic.

6. The method of claim 1, wherein the selectively invoking the first functionality of TA logic or bypassing the first functionality of the TA logic comprises:
controlling a functional block of the TA logic providing the first functionality of the TA logic to forego providing the first functionality with respect to at least one request for content.

7. The method of claim 6, wherein the controlling a functional block of the TA logic comprises:
providing by the TA control logic an advisory parameter not to chunk the at least one request for content.

8. The method of claim 1, wherein the attribute of the user agent's request comprises at least one of:
a uniform resource identifier (URI) of data being requested from the content server;
a file extension of data being requested from the content server; or information regarding the user agent making the request.

9. The method of claim 1, wherein the attribute of the content server comprises at least one of:
byte range request support by the content server;
request forbidden by the content server;
request range not-satisfiable by the content server; or
a response code provided by the server determined to be indicative of content server suitability for transport acceleration operation.

10. The method of claim 1, wherein the selectively invoking the first functionality of the TA logic or bypassing the first functionality of the TA logic comprises:
determining whether the one or more acceleration selection attributes meet one or more criteria of an exclude list; and
in response to determining that the one or more acceleration selection attributes meet the one or more criteria of the exclude list, bypassing the first functionality of the TA logic.

11. The method of claim 1, wherein the selectively invoking the first functionality of the TA logic or bypassing the first functionality of the TA logic comprises:
determining whether the one or more acceleration selection attributes meet one or more criteria of an exclude list; and
in response to determining that the one or more acceleration selection attributes do not meet the one or more criteria of an exclude list:
determining whether the one or more acceleration selection attributes meets one or more criteria of an include list; and
in response to determining that the one or more acceleration selection attributes meet one or more criteria of the include list, invoking the first functionality of the TA logic.

12. The method of claim 11, further comprising:
populating at least one of the exclude list or the include list using learning logic identifying operation indicative of transport acceleration operation support.

13. The method of claim 12, wherein the operation indicative of transport acceleration operation support comprises at least one of support for byte range requests, no support for byte range requests, requests resulting in a forbidden response, or requests resulting in a range not-satisfiable response.

14. The method of claim 1, wherein the attribute of the content server was derived from a response from the content server in response to a request made by the client device.

15. The method of claim 14, wherein the selectively invoking the first functionality of the TA logic or bypassing the first functionality of the TA logic comprises:
determining whether the content server is included on a probing list; and
in response to determining that the content server is included on the probing list, controlling the TA logic to make the request as a probing request for determining suitability of the content server for operation of the first functionality of the TA logic.

16. The method of claim 15, wherein the selectively invoking the first functionality of the TA logic or bypassing the first functionality of the TA logic comprises:
determining whether the content server is suitable for operation of the first functionality of the TA logic based upon the response to the request; and
in response to determining that the content server is not suitable for operation of the first functionality of the TA logic, adding the content server to an exclude list for bypassing of the first functionality of the TA logic with respect to communication of the content between the client device and the content server.

17. An apparatus comprising:
means for transport accelerator (TA) control logic obtaining one or more acceleration selection attributes comprising at least one of:
an attribute of a user agent's request for content from a content server; or
an attribute of the content server; and
means for selectively invoking first functionality of transport accelerator (TA) logic of a client device to obtain the content from the content server or bypassing the first functionality of the TA logic of the client device to obtain the content from the content server based on the one or more acceleration selection attributes obtained by the TA control logic of the client device, the first functionality of the TA logic of the client device comprising subdividing the user agent's request for content into a plurality of chunk requests for requesting chunks of the content from the content server to provide accelerated delivery of the content to the client device.

18. The apparatus of claim 17, wherein the means for selectively invoking the first functionality of TA logic or bypassing the first functionality of the TA logic comprises means for bypassing the first functionality of the TA logic; and the apparatus further comprises:
means for invoking second functionality of the TA logic of the client device when bypassing the first functionality of the TA logic.

19. The apparatus of claim 18, wherein the second functionality of the TA logic provides communication of the content via a plurality of connections established between the client device and the content server.

20. The apparatus of claim 18, wherein the second functionality of the TA logic provides port recovery with respect to communication of the content between the client device and the content server.

21. The apparatus of claim 17, wherein the means for selectively invoking the first functionality of TA logic or bypassing the first functionality of the TA logic comprises:
means for routing data to bypass a functional block of the TA logic providing the first functionality of the TA logic.

22. The apparatus of claim 17, wherein the means for selectively invoking the first functionality of TA logic or bypassing the first functionality of the TA logic comprises:
means for controlling a functional block of the TA logic providing the first functionality of the TA logic to forego providing the first functionality with respect to at least one request for content.

23. The apparatus of claim 22, wherein the means for controlling a functional block of the TA logic comprises:
means for providing by the TA control logic an advisory parameter not to chunk the at least one request for content.

24. The apparatus of claim 17, wherein the attribute of the user agent's request comprises at least one of:
a uniform resource identifier (URI) of data being requested from the content server;
a file extension of data being requested from the content server; or
information regarding the user agent making the request.

25. The apparatus of claim 17, wherein the attribute of the content server comprises at least one of:
byte range request support by the content server;
request forbidden by the content server;
request range not-satisfiable by the content server; or
a response code provided by the server determined to be indicative of content server suitability for transport acceleration operation.

26. The apparatus of claim 17, wherein the means for selectively invoking the first functionality of the TA logic or bypassing the first functionality of the TA logic comprises:
means for determining whether the one or more acceleration selection attributes meet one or more criteria of an exclude list; and
means for bypassing the first functionality of the TA logic in response to a determination that the one or more acceleration selection attributes meet the one or more criteria of the exclude list.

27. The apparatus of claim 17, wherein the means for selectively invoking the first functionality of the TA logic or bypassing the first functionality of the TA logic comprises:
means for determining whether the one or more acceleration selection attributes meet one or more criteria of an exclude list; and
means for determining whether the one or more acceleration selection attributes meets one or more criteria of an include list in response to a determination that the one or more acceleration selection attributes do not meet the one or more criteria of an exclude list; and
means for invoking the first functionality of the TA logic in response to a determination that the one or more acceleration selection attributes meet one or more criteria of the include list.

28. The apparatus of claim 27, further comprising:
means for populating at least one of the exclude list or the include list using learning logic identifying operation indicative of transport acceleration operation support.

29. The apparatus of claim 27, wherein the means for selectively invoking the first functionality of the TA logic or bypassing the first functionality of the TA logic comprises:
means for determining whether the content server is included on a probing list; and
means for controlling the TA logic to make the request as a probing request for determining suitability of the content server for operation of the first functionality of the TA logic in response to a determination that the content server is included on the probing list.

30. The apparatus of claim 19, wherein the means for selectively invoking the first functionality of the TA logic or bypassing the first functionality of the TA logic comprises:
means for determining whether the content server is suitable for operation of the first functionality of the TA logic based upon the response to the request; and
means for adding the content server to an exclude list for bypassing of the first functionality of the TA logic with respect to communication of the content between the client device and the content server in response to a determination that the content server is not suitable for operation of the first functionality of the TA logic.

31. A computer program product comprising:
a computer-readable medium having program code recorded thereon, said program code comprising:
program code to obtain, by transport accelerator (TA) control logic, one or more acceleration selection attributes comprising at least one of:
an attribute of a user agent's request for content from a content server; or
an attribute of the content server; and
program code to selectively invoke first functionality of transport accelerator (TA) logic of a client device to obtain the content from the content server or bypassing the first functionality of the TA logic of the client device to obtain the content from the content server based on the one or more acceleration selection attributes obtained by the TA control logic of the client device, the first functionality of the TA logic of the client device comprising subdividing the user agent's request for content into a plurality of chunk requests for requesting chunks of the content from the content server to provide accelerated delivery of the content to the client device.

32. The computer program product of claim 31, further comprising:
program code to invoke second functionality of the TA logic of the client device when bypassing the first functionality of the TA logic.

33. The computer program product of claim 31, wherein the program code to selectively invoke the first functionality of TA logic or bypassing the first functionality of the TA logic comprises:
program code to route data to bypass a functional block of the TA logic providing the first functionality of the TA logic.

34. The computer program product of claim 31, wherein the program code to selectively invoke the first functionality of TA logic or bypassing the first functionality of the TA logic comprises:
program code to control a functional block of the TA logic providing the first functionality of the TA logic to forego providing the first functionality with respect to at least one request for content.

35. The computer program product of claim 34, wherein the program code to control a functional block of the TA logic comprises:
program code to provide by the TA control logic an advisory parameter not to chunk the at least one request for content.

36. The computer program product of claim 31, wherein the program code to selectively invoke the first functionality of the TA logic or bypassing the first functionality of the TA logic comprises:
program code to determine whether the one or more acceleration selection attributes meet one or more criteria of an exclude list; and
program code to determine whether the one or more acceleration selection attributes meets one or more criteria of an include list in response to determining that the one or more acceleration selection attributes do not meet the one or more criteria of an exclude list; and
program code to invoke the first functionality of the TA logic in response to determining that the one or more acceleration selection attributes meet one or more criteria of the include list.

37. The computer program product of claim 36, further comprising:
program code to populate at least one of the exclude list or the include list using learning logic identifying operation indicative of transport acceleration operation support.

38. The computer program product of claim 31, wherein the program code to selectively invoke the first functionality of the TA logic or bypassing the first functionality of the TA logic comprises:
program code to determine whether the content server is included on a probing list; and
program code to control the TA logic to make the request as a probing request for determining suitability of the content server for operation of the first functionality of the TA logic in response to determining that the content server is included on the probing list.

39. An apparatus configured for wireless communication, said apparatus comprising
at least one processor; and
a memory coupled to said at least one processor,
wherein said at least one processor is configured:
to obtain one or more acceleration selection attributes by transport accelerator (TA) control logic, wherein the one or more acceleration selection attributes comprise at least one of:
an attribute of a user agent's request for content from a content server; or
an attribute of the content server; and
to selectively invoke first functionality of transport accelerator (TA) logic of a client device to obtain the content from the content server or bypassing the first functionality of the TA logic of the client device to obtain the content from the content server based on the one or more acceleration selection attributes obtained by the TA control logic of the client device, the first functionality of the TA logic of the client device comprising subdividing the user agent's request for content into a plurality of chunk requests for requesting chunks of the content from the content server to provide accelerated delivery of the content to the client device.

40. The apparatus of claim 39, wherein the at least one processor is configured to:
determine whether the one or more acceleration selection attributes meet one or more criteria of an exclude list; and
bypass the first functionality of the TA logic in response to a determination that the one or more acceleration selection attributes meet the one or more criteria of the exclude list.

41. The apparatus of claim 39, wherein the at least one processor is configured to:
determine whether the one or more acceleration selection attributes meet one or more criteria of an exclude list;
determine whether the one or more acceleration selection attributes meets one or more criteria of an include list in response to a determination that the one or more acceleration selection attributes do not meet the one or more criteria of an exclude list; and
invoke the first functionality of the TA logic in response to a determination that the one or more acceleration selection attributes meet one or more criteria of the include list.

42. The apparatus of claim 39, wherein the at least one processor is configured to:
determine whether the content server is included on a probing list; and
control the TA logic to make the request as a probing request for determining suitability of the content server for operation of the first functionality of the TA logic in response to a determination that the content server is included on the probing list.
